(19) United States
(12) Patent Application Publication
(10) Pub. No.: US 2019/0116574 A1
(43) Pub. Date: Apr. 18, 2019

(54) POSITION TRACKING SYSTEM, POSITIONING APPARATUS, AND POSITION TRACKING METHOD

(71) Applicant: Lite-On Technology Corporation, Taipei (TW)

(72) Inventor: Chia-Ching Wu, Taipei (TW)

(73) Assignee: Lite-On Technology Corporation, Taipei (TW)

(21) Appl. No.: 15/839,862

(22) Filed: Dec. 13, 2017

(30) Foreign Application Priority Data
Oct. 16, 2017 (TW) 106135276

(51) Int. Cl. H04W 64/00; H04L 29/08

(52) U.S. Cl. CPC H04W 64/00; H04W 88/08; H04L 67/12

(57) ABSTRACT

A position tracking system, a positioning apparatus, and a position tracking method are provided. The position tracking system includes first and second transceiving apparatuses and a positioning apparatus. The first transceiving apparatus supports a first communication technology using low power wide area network (LPWAN) technology, the second transceiving apparatus supports a second communication technology different from the first communication technology. The positioning apparatus transmits positioning data based on the first communication technology, and the first transceiving apparatus transmits a confirmation message in response to receiving of the positioning data. The positioning apparatus further switches to transmit the positioning data based on the second communication technology in response to not receiving the confirmation message from the first transceiving apparatus. Accordingly, the signal coverage rate is increased due to the two communication technologies, and power is saved based on the switching operation.

### CROSS REFERENCE TO RELATED APPLICATION

This application claims the priority benefit of Taiwan application serial no. 106135276, filed on Oct. 16, 2017. The entirety of the above-mentioned patent application is hereby incorporated by reference herein and made a part of specification.

### BACKGROUND OF THE DISCLOSURE

### 1. Field of the Disclosure

The disclosure is related to a positioning technology, in particular, related to a position tracking system, a positioning apparatus, and a position tracking method based on low power wide area network (LPWAN).

### 2. Description of Related Art

For the need of preventing theft, avoiding getting lost, conducting private investigation, tracking and recording trace, position tracking apparatuses supporting satellite navigation systems (e.g., a global positioning system (GPS), a global navigation satellite system (GLONAS), a BeiDou navigation satellite system, and so on) serve to record positioning information, e.g., latitude and longitude. The existing position tracking apparatuses on the market are usually equipped with a mobile communication module, such as the second generation (2G) or the third generation (3G) mobile communication module, so that current positions or traces of a position tracking apparatus may be remotely monitored. However, such mobile communication modules are not adapted to long-term (e.g., more than one day, five days, etc.) position tracking due to short stand-by time resulting from great power consumption. In addition, the position tracking apparatus is subject to signal coverage of base stations, and the position tracking apparatus may not be able to return positioning information immediately when located in a remote area. Although establishment of new base stations may enlarge the coverage, such establishment requires further considerations of costs, local population, and residents' attitudes and may not be the best solution. In view of the above, it can be learned that the current technology for position tracking has to be improved.

### SUMMARY OF THE DISCLOSURE

Accordingly, an embodiment of the disclosure provides a position tracking system, a positioning apparatus, and a position tracking method, in which a signal coverage rate is increased at low costs through utilizing two kinds of communication technologies which may be switched from one to the other depending on situations, thereby saving power and increasing possibilities of instantly returning positioning data successfully.

According to an embodiment of the disclosure, a position tracking system includes a first transceiving apparatus, a second transceiving apparatus, and a positioning apparatus. The first transceiving apparatus supports a first communication technology using a low power wide area network (LPWAN) technology. The second transceiving apparatus supports a second communication technology different from the first communication technology. The positioning apparatus transmits positioning data based on the first communication technology, and the first transceiving apparatus transmits a confirmation message in response to receiving the positioning data. The positioning apparatus switches to transmit the positioning data based on the second communication technology in response to not receiving the confirmation message from the first transceiving apparatus.

In an embodiment of the disclosure, the positioning apparatus transmits the positioning data based on the second communication technology, the second transceiving apparatus transmits the confirmation message in response to receiving the positioning data, and the positioning apparatus switches to transmit the positioning data based on the first communication technology in response to not receiving the confirmation message from the second transceiving apparatus.

In an embodiment of the disclosure, the positioning apparatus enables the positioning data to carry the confirmation message and transmits the positioning data based on the first communication technology, and the first transceiving apparatus transmits the confirmation message again in response to the receiving the positioning data.

In an embodiment of the disclosure, the confirmation message carried by the positioning data is the confirmation message which is received by the positioning apparatus from the first transceiving apparatus while the positioning apparatus wakes up after N seconds of non-transmission, wherein N is greater than 0.

In an embodiment of the disclosure, the first communication technology is a long range (LoRa) technology, the second communication technology is a narrow band Internet of thing (NB-IoT) technology, the first transceiving apparatus is a LoRa transceiver, the second transceiving apparatus is a NB-IoT base station, and the positioning apparatus includes a LoRa communication module corresponding to the first communication technology and a NB-IoT communication module corresponding to the second communication technology; in response to not receiving a signal of the NB-IoT base station, the positioning apparatus turns off the NB-IoT communication module and turns on the LoRa communication module, such that the positioning data is transmitted to the LoRa transceiver through the LoRa communication module.

In an embodiment of the disclosure, the first communication technology is a LoRa technology, the second communication technology is a NB-IoT technology, the first transceiving apparatus is a LoRa transceiver, the second transceiving apparatus is a NB-IoT base station, and the positioning apparatus includes a LoRa communication module corresponding to the first communication technology and a NB-IoT communication module corresponding to the second communication technology. In response to not receiving the confirmation message from the LoRa transceiver, the positioning apparatus turns off the LoRa communication module and turns on the NB-IoT communication module, such that the positioning data is transmitted to the NB-IoT base station through the NB-IoT communication module.

In an embodiment of the disclosure, in response to not receiving a signal from the first transceiving apparatus and the second transceiving apparatus, the positioning apparatus records a plurality of positioning data which are not delivered and disables transmission of the plurality of positioning data, and then the positioning apparatus transmits the plurality of positioning data after a waiting period.

In an embodiment of the disclosure, the position tracking system further includes a server, which is connected to the first transceiving apparatus and the second transceiving apparatus and transmits a warning message according to the positioning data transmitted by the first transceiving apparatus or the second transceiving apparatus.

According to an embodiment of the disclosure, a position tracking method is adapted to a positioning apparatus and includes following steps. Positioning data is transmitted based on a first communication technology using a LPWAN technology. A confirmation message is received in response to the positioning data. The positioning apparatus switches to transmit the positioning data based on a second communication technology different from the first communication technology and transmits the positioning data in response to not receiving the confirmation message based on the first communication technology.

In an embodiment of the disclosure, after the step of switching to transmit the positioning data based on the second communication technology different from the first communication technology, the position tracking method further includes following steps. The positioning data is transmitted based on the second communication technology. The confirmation message is received in response to the positioning data. In response to not receiving the confirmation message based on the second communication technology, the position tracking method further includes switching to transmit the positioning data based on the first communication technology.

In an embodiment of the disclosure, after the step of receiving the confirmation message in response to the positioning data, the position tracking method further includes following steps. The positioning data is enabled to carry the confirmation message, and the positioning data is transmitted based on the first communication technology. The confirmation message is received again.

In an embodiment of the disclosure, the confirmation message carried by the positioning data is the received confirmation message which is transmitted based on the first communication technology while being waken up after N seconds of non-transmission, wherein N is greater than 0.

In an embodiment of the disclosure, the step of switching to transmit the positioning data based on the second communication technology different from the first communication technology includes following steps. Transmission of the positioning data based on the first communication technology is disabled, and the positioning data is transmitted based on the second communication technology in response to not receiving a signal based on the first communication technology.

According to an embodiment of the disclosure, a positioning apparatus includes a first communication module, a second communication module, a positioning module, and a processing circuit. The first communication module transceives signals based on a first communication technology using a LPWAN technology. The second communication module transceives signals based on a second communication technology different from the first communication technology. The positioning module obtains positioning data. The processing circuit is coupled to the first communication module, the second communication module, and the positioning module, transmits the positioning data through the first communication module, receives a confirmation message in response to the positioning data through the first communication module, and switches to transmit the positioning data through the second communication module in response to not receiving the confirmation message by the first communication module based on the first communication technology.

In an embodiment of the disclosure, the processing circuit transmits the positioning data through the second communication module and receives the confirmation message in response to the positioning data through the second communication module, and the processing circuit switches to transmit the positioning data through the first communication module in response to not receiving the confirmation message by the second communication module based on the second communication technology.

In an embodiment of the disclosure, the processing circuit enables the positioning data to carry the confirmation message, transmits the positioning data through the first communication module, and receives the confirmation message again through the first communication module.

In an embodiment of the disclosure, the confirmation message carried by the positioning data is the confirmation message which is received by the first communication module from the first transceiving apparatus while the first communication module wakes up after N seconds of non-transmission, wherein N is greater than 0.

In an embodiment of the disclosure, the first communication technology is a LoRa technology, the second communication technology is a NB-IoT technology, the first communication module is a LoRa communication module, and the second communication module is a NB-IoT communication module. The processing circuit turns off the NB-IoT communication module and turns on the LoRa communication module to transmit the positioning data in response to not receiving a signal by the NB-IoT communication module based on the second communication technology.

In an embodiment of the disclosure, the first communication technology is a LoRa technology, the second communication technology is a NB-IoT technology, the first communication module is a LoRa communication module, and the second communication module is a NB-IoT communication module. The processing circuit turns off the LoRa communication module and turns on the NB-IoT communication module to transmit the positioning data in response to not receiving the confirmation message by the LoRa communication module based on the first communication technology.

In an embodiment of the disclosure, the processing circuit records a plurality of positioning data which are not delivered, disables transmission of the plurality of positioning data, and transmits the plurality of positioning data based on one of the first communication technology and the second communication technology after a waiting period in response to not receiving a signal based on the first communication technology and the second communication technology.

Based on the above, in the embodiment of the disclosure, the signal coverage rate may be increased by using the LoRa transceiver with lower costs. The positioning apparatus may also switch to transmit the positioning data based on the other communication technology on condition of different signal coverages, such that the positioning data may be continuously returning, and that power may be saved. In addition, the LoRa transceiver may also provide the confirmation message, so that the positioning apparatus may confirm the positioning data is delivered actually.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a position tracking system according to an embodiment of the disclosure.

FIG. 2 is a flowchart of a position tracking method according to an embodiment of the disclosure.

FIG. 3 is a timing diagram of a signal confirmation procedure according to an embodiment of the disclosure.

FIG. 4 is a schematic view of a first exemplary scenario.

FIG. 5 is a schematic view of a second exemplary scenario.

### DESCRIPTION OF THE EMBODIMENTS

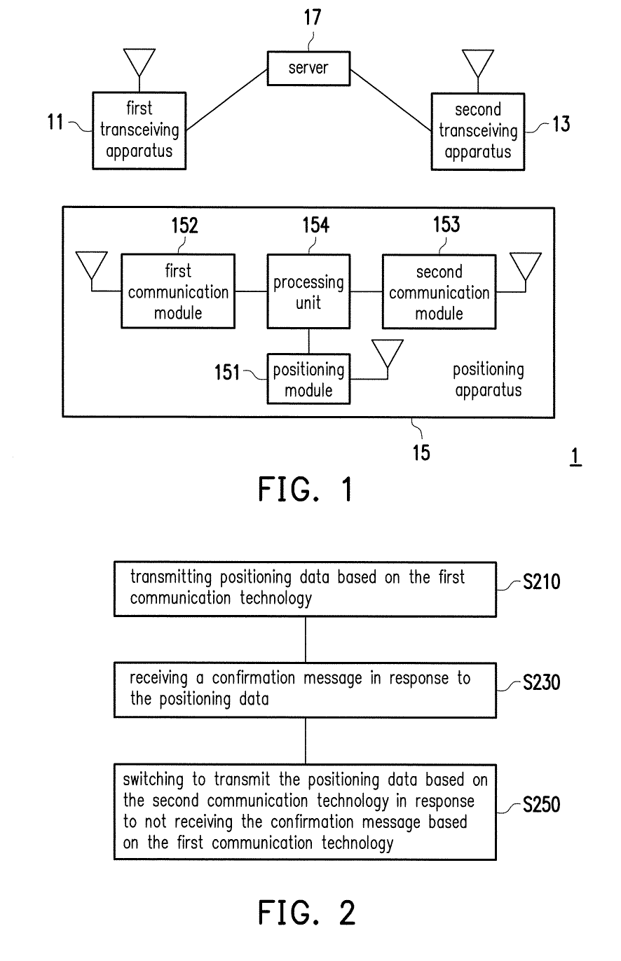

FIG. 1 is a schematic view of a position tracking system 1 according to an embodiment of the disclosure. The position tracking system 1 includes a first transceiving apparatus 11, a second transceiving apparatus 13, a positioning apparatus 15, and a server 17. It should be noted that the number of the above apparatuses is not limited by the embodiments of the disclosure and may be modified depending on requirements of users.

The first transceiving apparatus 11 supports a first communication technology using a low power wide area network (LPWAN) technology (e.g., a long range (LoRa) technology, a narrow band Internet of thing (NB-IoT), Sigfox, LTE advanced for machine type communications (LTE-MTC), and the like), such that the first transceiving apparatus 11 can transmit signals to and receive signals from an equipment supporting the same communication technology.

The second transceiving apparatus 13 supports a second communication technology different from the first communication technology (e.g., other LPWAN communication technologies different from the first communication technology, other long-range-low-power-consumption communication technologies, an machine to machine communication technology, or the second, third or fourth generation (2G, 3G, 4G) mobile communication technology), such that the second transceiving apparatus 13 can transmit signals to and receive signals from an equipment supporting the same communication technology.

The positioning apparatus 15 may be a position tracking apparatus, a position transmitter, or the like, and the positioning apparatus 15 may be designed as a wearable apparatus (e.g., a smart watch, a bracelet, a garment or clothing, or shoes) or in other forms, such as a key, a mobile phone, a wallet, a backpack, and so forth. The positioning apparatus 15 includes (and is not limited to) at least a positioning module 151, a first communication module 152, a second communication module 153, and a processing circuit 154.

The positioning module 151 supports satellite navigation systems, such as GPS, GLONAS, BeiDou navigation satellite system, and so on. A chip, a processor, or an electric circuit of the positioning module 151 may receive signals sent by a satellite navigation system through an antenna of the positioning module 151, and the signals may be processed by a wave filter, an analog-to-digital converter, or the like included in the positioning module 151, so as to obtain positioning data (e.g., latitude and longitude) of the positioning apparatus 15.

The first communication module 152 is a communication processor supporting the first communication technology (e.g., a LoRa communication module, a Sigfox communication module, or the like) which may be integrated with or has built-in hardware components, such as an antenna, a wave filter, an analog-to-digital converter, an amplifier, and the like, thereby mutually transmitting signals to and receiving signals from the first transceiving apparatus 11. The second communication module 153 is a communication processor supporting the second communication technology (e.g., a 4G communication module, a Bluetooth communication module, or the like) which may be integrated with or has built-in hardware components, such as an antenna, a wave filter, an analog-to-digital converter, an amplifier, and the like, thereby mutually transmitting signals to and receiving signals from the second transceiving apparatus 13.

The processing circuit 154 may be a central processing unit (CPU), a micro processing unit (MCU), a digital signal processor (DSP), a programmable controller, a chip, an application-specific integrated circuit (ASIC), other similar elements, or a combination thereof. In this embodiment, the processing circuit 154 serves to perform all operations of the positioning apparatus 15.

The server 17 is any type of server, such as a cloud server, a database, an application program server, an IoT application server, or the like. Here, the server 17 is connected to the first transceiving apparatus 11 or the second transceiving apparatus 13 to receive the positioning data or other data and to analyze and process the received data and report the received data. Details of the operation will be described in the following embodiments.

The operation of the position tracking system 1 of the embodiment of the disclosure will be described in detail in several embodiments below for better understanding. FIG. 2 is a flowchart of a position tracking method according to an embodiment of the disclosure. Referring to FIG. 2, the method provided in the embodiment is adapted to each apparatus in the position tracking system 1 depicted in FIG. 1. Hereinafter, the method provided in the embodiment will be described with reference to the devices and modules of the positioning apparatus 150. Each step of the method may be adjusted according to actual situations, and the disclosure is not limited thereto.

After the processing circuit 154 obtains the positioning data from the positioning apparatus 150 through the positioning module 151, the positioning data is transmitted through the first communication module 152 (step S230). Particularly, if the first communication module 152 can still obtain a signal from the first transceiving apparatus 11 (e.g., confirmed by the received signal strength indication(RSSI) which is greater than a specific value, by receipt of the confirmation message, and so on) to know whether the positioning apparatus 150 is still within the signal coverage of the first transceiving apparatus 11, the positioning data can still be transmitted through the first communication module 152.

On the other hand, the first transceiving apparatus 11 transmits the confirmation message in response to receiving the positioning data from the positioning apparatus 15, so as to confirm receipt of the positioning data. When the processing circuit 154 receives the confirmation message through the first communication module 152, the processing circuit 154 can be aware of the fact that the positioning data is received and the positioning apparatus 150 is located within the signal coverage of the first transceiving apparatus 11 (step S230). In addition, if the first communication module 152 can still receive a signal from the first transceiving apparatus 11, the positioning data may be transmitted based on the first communication technology.

In fact, among the current communication technologies conforming to the LoRa technology, the positioning apparatus 15 can be informed of neither the signal strength of the first transceiving apparatus 11 nor whether the signals are actually delivered.

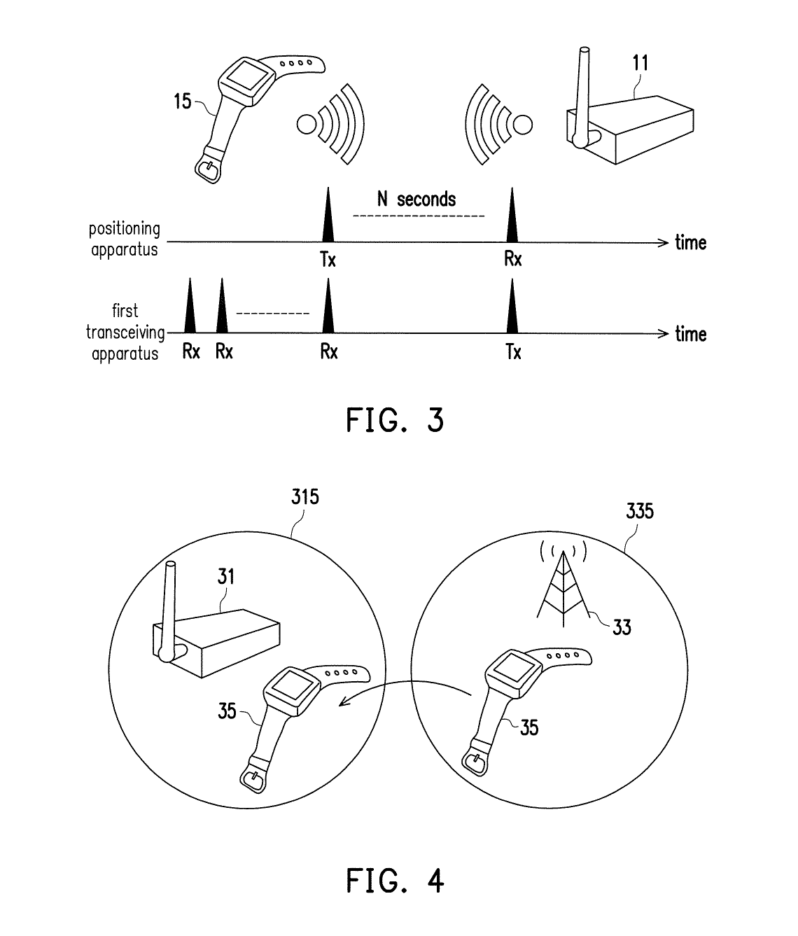

To solve the above-mentioned problems, in an embodiment of the disclosure, whether the positioning data is received by the first transceiving apparatus 11 may be further confirmed through a signal confirmation procedure. Particularly, as shown in FIG. 3, which is a timing diagram of the signal confirmation procedure, the first transceiving apparatus 11 is, for example, a LoRa transceiver. The processing circuit 154 enables the positioning data to carry a confirmation message which is transmitted by the LoRa transceiver and received (shown as RX at the timeline in the figure) and by the first communication module 152 when the first communication module 152 wakes up after N seconds (N is greater than 0), and the processing circuit 154 transmits the positioning data through the first communication module 152. The confirmation message is filled in a payload or specific blanks or columns of a header. After the LoRa transceiver receives the positioning data carrying the confirmation message, another confirmation message is transmitted according to the content of the confirmation message after N seconds, such that the processing circuit 154 may receive the confirmation message again through the first communication module 152; thereby, one process of transceiving the positioning data is completed.

On the other hand, the processing circuit 154 switches to transmit the positioning data through the second communication module 153 in response to not receiving the confirmation message by the first communication module 152 based on the first communication technology (step S250). Particularly, when the first communication module 152 cannot obtain the confirmation message from the first transceiving apparatus 11, the processing circuit 154 determines that the positioning apparatus 15 is not within the signal coverage of the first transceiving apparatus 11, and thus the positioning data cannot be delivered through the first communication module 152. The processing circuit 154 may turn off the first communication module 152 (or disable transmission of the positioning data based on the first communication technology) and turn on the second communication module 153 to transmit the positioning data.

If the second communication module 153 receives the signal from the second transceiving apparatus 13, the processing circuit 154 may keep on transmitting the positioning data through the second communication module 153. If the second communication technology conforms to the NB-IoT communication standard or the like (i.e., the second transceiving apparatus 13 is a base station), the base station only needs to transmit the confirmation message in response to receiving the positioning data, and the receipt of the confirmation message by the positioning apparatus 15 may ensure the receipt of the positioning data by the base station.

On the other hand, in response to not receiving the signal based on the second communication technology by the second communication module 153 (e.g., not receiving the confirmation signal, not receiving the received signal strength indication (RSSI) less than a specific value, or not receiving other signals from the base station), the processing circuit 154 may turn off the second communication module 153 and switch to transmit the positioning data through the first communication module 152.

That is, as long as the first communication module 152 or the second communication module 153 currently acting to transmit the positioning data cannot receive a signal from the corresponding transceiving apparatus (i.e., the first transceiving apparatus 11 or the second transceiving apparatus 13), the processing circuit 154 may turn off or disable the currently used communication module or the function thereof and turn on the other communication module to transmit the positioning data. In view of this, the positioning apparatus 15 provided in the embodiment of the disclosure supports two kinds of communication technologies, resulting in an increasing possibility to communicate with the transceiving apparatuses supporting different communication technologies. Thereby, the limitation of the insufficient number of transceiving apparatuses supporting one single communication technology or the limitation of excessive costs of establishing the transceiving apparatuses may not be applicable herein, and power may be further saved based on the operation of switching communication modules (i.e., only one of the communication modules serves to transmit the positioning data, while the other is turned off or disabled.)

In some embodiments, the currently used communication system may not be able to function temporarily (e.g., for 5 seconds or 10 seconds); in response to not receiving the confirmation message for the first time, the positioning apparatus 15 may transmit positioning data based on the same communication technology, and the positioning apparatus 15 switches to transmit the positioning data based on the other communication technology after not receiving the confirmation message for the second time, so as to reduce the frequency of switching to different modules, thereby reducing power consumption.

To effectively increase the signal coverage rate, the overlapping area of signal coverages of the first transceiving apparatus 11 and the second transceiving apparatus 13 may be reduced as much as possible, while possible adjustment may still be made in consideration of actual needs. Since costs of establishing the transceiving apparatus conforming to the LoRa technology are lower than the costs of establishing the NB-IoT or LTE-MTC transceiving apparatuses (or base stations), the transceiving apparatus conforming to the LoRa technology may be established at regions not covered by the existing NB-IoT or LTE-MTC base stations, so as to reduce costs.

In addition, in some embodiments, the processing circuit 154 may determine whether the positioning apparatus 15 moves. If the positioning apparatus 15 does not move, the first communication module 152 or the second communication module 153 may not be waken up to transmit the positioning data; if the movement of the positioning apparatus 15 is detected, the first communication module 152 or the second communication module 153 is waken up to transmit the positioning data, so as to save power.

For better understanding, different exemplary scenarios are provided below without departing from the spirit of the disclosure.

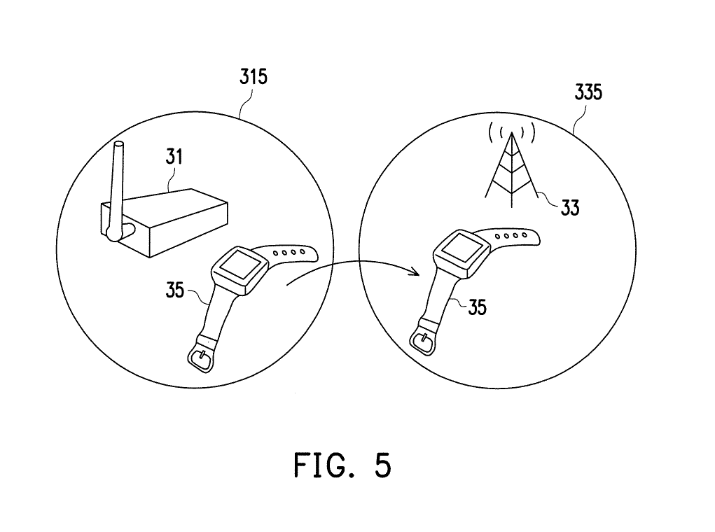

Please refer to FIG. 4, which is a schematic view of a first exemplary scenario. It is assumed that a smart watch 35 is worn by one elderly person, and the smart watch 35 is one exemplary form of the above-mentioned positioning apparatus 15. A NB-IoT base station 33 is located around the nursing home where the elderly person stays, such that the positioning data obtained by the smart watch 35 may be successfully transmitted to the NB-IoT base station 33 when the elderly person moves within a signal coverage 335 of the NB-IoT base station 33. When the elderly person moves from the signal coverage 335 to a signal coverage 315 of the LoRa transceiver 31, the signal strength received by the smart watch 35 is less than a specific value, or no signal sent by the NB-IoT base station 33 is received. In this case, the smart watch 35 turns off the NB-IoT communication module and turns on the LoRa communication module, such that the positioning data is transmitted to the LoRa transceiver 31 through the LoRa communication module. Accordingly, even though the elderly person is far away from the nursing home, the location of the elderly person can be tracked without interruptions.

Please refer to FIG. 5, which is a schematic view of a second exemplary scenario. When the elderly person moves from the signal coverage 315 to the signal coverage 335, the smart watch 35 cannot receive the confirmation signal from the LoRa transceiver 31. In this case, the smart watch 35 turns off the LoRa communication module and turns on the NB-IoT communication module, such that the positioning data is transmitted to the NB-IoT base station 33 through the NB-IoT communication module. In view of the two scenarios, in the embodiment of the disclosure, the signal transmission coverage of the smart watch 35 (i.e., the set of the signal coverage 315 and 335) may be actually expanded. Compared to the position tracking apparatus only supporting one single communication technology, the position tracking apparatus provided in the embodiment of the disclosure is able to keep on tracking the location.

Inevitably, it is difficult to deploy the transceiving apparatuses in some regions. In the third exemplary scenario, the elderly person moves to a region outside of the signal coverages 315 and 335. The smart watch 35 may record all positioning data which are not delivered or a trace analyzed according to the positioning data and transmit a collection or the trace of the positioning data which are not delivered, and the smart watch does not transmit the positioning data obtained at a time until the positioning data is actually received. In addition, frequently switching between communication modules consumes power, and thus the smart watch 35 may directly turn off both of the LoRa communication module and the NB-IoT communication module (i.e., disable transmission of the positioning data); after a waiting period, the smart watch 35 switches to the other communication module, and the waiting period may be prolonged due to successive and multiple number of times of not receiving signals. For example, the LoRa communication module is turned off for 5 seconds if not receiving signals, and then the NB-IoT communication module is turned on to transmit the positioning data. If the two communication modules are switched from one to the other for three times, and neither of the communication modules receives the signal, the waiting period is prolonged to 10 seconds, and so forth. However, the maximum waiting period should be determined, e.g., one minute, five minutes, or the like.

Referring to FIG. 1 again, in addition to the data transmission between the positioning apparatus and the transceiving apparatus, the server 17 provided in the embodiment of the disclosure may further obtain the positioning data received by the first transceiving apparatus 11 or the second transceiving apparatus 13 from the positioning apparatus 15, and the server 17 may transmit a warning message based on the positioning data.

For example, the server 17 may determine the range of alert for different positioning apparatuses 15. As shown in FIG. 4, if the range of alert is the signal coverage 335, and the server 17 detects that the smart watch 35 moves to the outside of the signal coverage 335, the server 17 may transmit the warning message to other preset apparatuses or directly report to departments concerned. Alternatively, the server 17 may send the warning message immediately as long as the smart watch 35 moves into the signal coverage 335.

In addition, the server 17 may set notifications for signal loss. If the receipt of the positioning data transmitted back from the positioning apparatus 15 is not detected within a set period (e.g., one minute or five minutes), the server 17 may transmit the warning message. The server 17 may be adapted to different time slots, different lengths of stay time, and specific areas. If it is detected that the positioning apparatus 15 is located more than 1 kilometer away from home at night (from 10 p.m. to 4 a.m.) for more than half an hour, the server 17 transmits the warning message. There are many possible exemplary scenarios for the server 17 to analyze contents of the positioning data and send reports based on alert conditions (e.g., time, location, etc.); people having ordinary skill in the art may make adjustments according to actual requirements, and the disclosure is not limited thereto.

To sum up, the positioning apparatus provided in an embodiment of the disclosure may switch to transmit the positioning data based on the other communication technology if the positioning data cannot be delivered based on one of the communication technologies; with such transceiving apparatuses capable of supporting the two communication technologies, the signal coverage rate may be increased. In addition, only one of the communication modules performs communication under actual operation, while the other is in a turned-off mode, a disabled mode, a sleep mode, or a stand-by mode, thereby saving power. In an embodiment of the disclosure, the transmission of data based on the LoRa technology is further confirmed by the confirmation message. On the other hand, in an embodiment of the disclosure, the automatic position tracking notification may be achieved by further analyzing the positioning data and notifying the departments concerned accordingly, so as to easily track elderly people, children, valuables, pets, etc.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A position tracking system, comprising:
a first transceiving apparatus, supporting a first communication technology using a low power wide area network (LPWAN) technology;
a second transceiving apparatus, supporting a second communication technology different from the first communication technology; and
a positioning apparatus, transmitting positioning data based on the first communication technology, wherein the first transceiving apparatus transmits a confirmation message in response to receiving the positioning data, and the positioning apparatus switches to transmit the positioning data based on the second communication technology in response to not receiving the confirmation message from the first transceiving apparatus.

2. The position tracking system of claim 1, wherein the positioning apparatus transmits the positioning data based on the second communication technology, the second transceiving apparatus transmits the confirmation message in response to receiving the positioning data, and the positioning apparatus switches to transmit the positioning data based on the first communication technology in response to not receiving the confirmation message from the second transceiving apparatus.

3. The position tracking system of claim 1, wherein the positioning apparatus enables the positioning data to carry the confirmation message and transmits the positioning data based on the first communication technology, and the first transceiving apparatus transmits the confirmation message again in response to receiving the positioning data.

4. The position tracking system of claim 3, wherein the confirmation message carried by the positioning data which is received by the positioning apparatus from the first transceiving apparatus while the positioning apparatus wakes up after N seconds, wherein N is greater than 0.

5. The position tracking system of claim 1, wherein the first communication technology is a long range (LoRa) technology, the second communication technology is a narrow band Internet of thing (NB-IoT) technology, the first transceiving apparatus is a LoRa transceiver, the second transceiving apparatus is a NB-IoT base station, the positioning apparatus comprises a LoRa communication module corresponding to the first communication technology and a NB-IoT communication module corresponding to the second communication technology, and in response to not receiving a signal of the NB-IoT base station, the positioning apparatus turns off the NB-IoT communication module and turns on the LoRa communication module, such that the positioning data is transmitted to the LoRa transceiver through the LoRa communication module.

6. The position tracking system of claim 2, wherein the first communication technology is a LoRa technology, the second communication technology is a NB-IoT technology, the first transceiving apparatus is a LoRa transceiver, the second transceiving apparatus is a NB-IoT base station, the positioning apparatus comprises a LoRa communication module corresponding to the first communication technology and a NB-IoT communication module corresponding to the second communication technology, and in response to not receiving the confirmation message from the LoRa transceiver, the positioning apparatus turns off the LoRa communication module and turns on the NB-IoT communication module, such that the positioning data is transmitted to the NB-IoT base station through the NB-IoT communication module.

7. The position tracking system of claim 1, wherein in response to not receiving a signal from the first transceiving apparatus and the second transceiving apparatus, the positioning apparatus records a plurality of positioning data which are not delivered, disables transmission of the plurality of positioning data, and then transmits the plurality of positioning data which are not delivered after a waiting period.

8. The position tracking system of claim 1, further comprising:
a server, connected to the first transceiving apparatus and the second transceiving apparatus and transmitting a warning message according to the positioning data transmitted by the first transceiving apparatus or the second transceiving apparatus.

9. A position tracking method adapted to a positioning apparatus and comprising:
transmitting positioning data based on a first communication technology using a LPWAN technology;
receiving a confirmation message in response to the positioning data; and
switching to transmit the positioning data based on a second communication technology different from the first communication technology in response to not receiving the confirmation message based on the first communication technology.

10. The position tracking method of claim 9, wherein after the step of switching to transmit the positioning data based on the second communication technology different from the first communication technology, the position tracking method further comprises:
transmitting the positioning data based on the second communication technology;
receiving the confirmation message in response to the positioning data; and
switching to transmit the positioning data based on the first communication technology in response to the not receiving the confirmation message based on the second communication technology.

11. The position tracking method of claim 9, wherein after the step of receiving the confirmation message in response to the positioning data, the position tracking method further comprises:
enabling the positioning data to carry the confirmation message and transmitting the positioning data based on the first communication technology; and
receiving the confirmation message again.

12. The position tracking method of claim 11, wherein the confirmation message carried by the positioning data is the received confirmation message which is transmitted based on the first communication technology while being waken up after N seconds, wherein N is greater than 0.

13. The position tracking method of claim 9, wherein the step of switching to transmit the positioning data based on the second communication technology different from the first communication technology comprises:
disabling transmission of the positioning data based on the first communication technology and transmitting the positioning data based on the second communication technology in response to not receiving a signal based on the first communication technology.

14. A positioning apparatus, comprising:
a first communication module, transceiving signals based on a first communication technology using a LPWAN technology;
a second communication module, transceiving signals based on a second communication technology different from the first communication technology;
a positioning module, obtaining positioning data; and
a processing circuit, coupled to the first communication module, the second communication module and the positioning module, transmitting the positioning data through the first communication module, receiving a confirmation message in response to the positioning data through the first communication module, and switching to transmit the positioning data through the second communication module in response to not receiving the confirmation message by the first communication module based on the first communication technology.

15. The positioning apparatus of claim 14, wherein the processing circuit transmits the positioning data through the second communication module and receives the confirmation message in response to the positioning data through the second communication module, and the processing circuit switches to transmit the positioning data through the first communication module in response to not receiving the confirmation message by the second communication module based on the second communication technology.

16. The positioning apparatus of claim 14, wherein the processing circuit enables the positioning data to carry the confirmation message, transmits the positioning data through the first communication module, and receives the confirmation message again through the first communication module.

17. The positioning apparatus of claim 16, wherein the confirmation message carried by the positioning data which is received by the first communication module from first transceiving apparatus while the first communication module wakes up after N seconds, wherein N is greater than 0.

18. The positioning apparatus of claim 14, wherein the first communication technology is a LoRa technology, the second communication technology is a NB-IoT technology, the first communication module is a LoRa communication module, the second communication module is a NB-IoT communication module, and the processing circuit turns off the NB-IoT communication module and turns on the LoRa communication module to transmit the positioning data in response to not receiving a signal by the NB-IoT communication module based on the second communication technology.

19. The positioning apparatus of claim 15, wherein the first communication technology conforms to a LoRa technology, the second communication technology conforms to a NB-IoT technology, the first communication module is a LoRa communication module, the second communication module is a NB-IoT communication module, and the processing circuit turns off the LoRa communication module and turns on the NB-IoT communication module to transmit the positioning data in response to not receiving the confirmation message by the LoRa communication module based on the first communication technology.

20. The positioning apparatus of claim 14, wherein in response to not receiving a signal based on the first communication technology and the second communication technology, the processing circuit records a plurality of positioning data which are not delivered, disables transmission of the plurality of positioning data, and then transmits the plurality of positioning data which are not delivered again based on one of the first communication technology and the second communication technology after a waiting period.
